(19) United States
(12) Patent Application Publication
(10) Pub. No.: US 2013/0042487 A1
(43) Pub. Date: Feb. 21, 2013

(54) BEARD TRIMMER HAVING AUTOMATIC POSITIONING OF THE CUTTING UNIT

(71) Applicant: Pierre Julemont, Soumagne (BE)

(72) Inventor: Pierre Julemont, Soumagne (BE)

(21) Appl. No.: 13/578,726

(22) PCT Filed: Sep. 20, 2010
(86) PCT No.: PCT/EP2010/063799

§ 371 Date: Oct. 31, 2012

(30) Foreign Application Priority Data
Feb. 10, 2010 (EP) 10153493.1

(51) Int. Cl. B26B 19/00; B26B 19/38; B26B 19/20

(52) U.S. Cl. 30/277.4; 30/289; 30/293

(57) ABSTRACT

The present invention relates to a motorized beard trimmer comprising a cutting unit with a cutting mechanism defining a cutting line and a comb defining a support point, said cutting unit being mounted so as to tilt on a handle, wherein the tilting axis of the cutting unit, the cutting line and the support point of the comb are globally aligned or superimposed, allowing said cutting unit to be automatically positioned tangentially to the shape of the face during trimming of the beard.

### FIELD OF THE INVENTION

The present invention relates to a beard trimmer, more commonly referred to as a “trimmer”, comprising a cutting unit that is mobile around an axis and that, in use, allows the automatic adjustment of the positioning of the cutting unit to the shape of the face. The beard trimmer comprises a comb serving as a support against the skin and allowing to adjust the distance between the cutting line and the skin, and thus the cutting length. The beard trimmer is therefore not a simple razor.

### STATE OF THE ART

For a user to be able to ensure quality work while using a beard trimmer provided with a cutting unit of the prior art, he must generally respect an optimal working angle between the beard trimmer and the curves encountered at the level of the chin, which forces him to continuously modify the angle of the handle relative to the face, thus making the results uncertain.

The cutting unit of a trimmer generally comprises at least one comb defining a support surface and a cutting mechanism defining a cutting line. The distance between the support surface and the cutting line is adjustable and defines the desired cutting length for the beard.

Document US 2008/0168662 A1 discloses a beard trimmer that may be used in two different positions, either in a position allowing to pull it, or in a position allowing to push it. It comprises a comb that tilts around an axis that is relatively distant from the support point of the comb, which does not allow free tilting of the cutting unit while following the curves of the chin.

Document WO 2009/081301 discloses a razor that does not comprise a comb to adjust the cutting length, but only a fixed blade and a mobile blade (see FIG. 2 of WO 2009/081301). There is no well-defined support point on that mechanism, which does not allow to trim the beard to a precise length. FIG. 0 of the present document illustrates the difficulty generated by the spacing of the cutting line and of the tilting axis on the one hand, and by the misalignment of the cutting line and of the tilting axis with the bearing force vector against the chin on the other hand. Around the chin, for example, when the cutting mechanism tilts, the cutting length becomes random.

Swiss document CH 353651 discloses a trimmer with a fixed blade and a mobile blade making up the cutting mechanism. This trimmer does not comprise a comb that could provide a support point to adjust the cutting length of a beard. Although it is mounted so as to tilt, the cutting mechanism can only adopt two fixed positions (reference 9 in FIG. 1 of CH 353651 A). This trimmer therefore does not comprise a cutting head that is able to freely tilt in order to automatically adapt to the curves of the face.

### AIMS OF THE INVENTION

The present invention aims to provide a beard trimmer that does not comprise the drawbacks of the prior art. It particularly aims to provide a beard trimmer allowing the automatic positioning of the support surface on the curves of the face by means of a light and mobile cutting unit comprising a tilting axis, a cutting line and a support point that are aligned and grouped together in the immediate vicinity of the skin during shaving.

### SUMMARY OF THE INVENTION

The present invention discloses a motorized beard trimmer comprising a cutting unit with a cutting mechanism that defines a cutting line and a comb that defines a support point, said cutting unit being mounted to as to tilt on a handle, wherein the tilting axis of the cutting unit, the cutting line and the support point of the comb are globally aligned or superimposed, allowing said cutting unit to be automatically positioned tangentially to the shape of the face during trimming of the beard.

The specific embodiments of the invention include at least one or a suitable combination of the following features:
the tilting axis of the cutting unit is materialized by pivot points located on the cutting mechanism;
the tilting axis of the cutting unit is materialized by pivot points located on the comb;
the tilting axis of the cutting unit is less than 8 mm, preferably less than 5 mm, from the support point of the comb;
the tilting angle (a) of the cutting unit around the tilting axis is greater than 10°, preferably greater than 20°;
the tilting angle (a) of the cutting unit around the tilting axis is between 15 and 90°;
the cutting unit is maintained in an idle position by a return spring that always brings said unit back into its initial pre-shaving position;
the distance between the support point of the comb and the cutting line may be adjusted by a device located on the handle;
the distance between the support point of the comb and the cutting line is adjusted by moving the cutting mechanism when the pivot points materializing the tilting axis are located on the comb;
the distance between the support surface of the comb and the cutting line is adjusted by moving the comb when the pivot points materializing the tilting axis are located on the cutting mechanism;
said adjustment is motorized, allowing to adapt the cutting length without interrupting the shaving;
the handle comprises a cutting length indicator;
the cutting length may be adjusted between 0.3 and 6 mm, preferably between 0.5 and 5 MM.

### SHORT DESCRIPTION OF THE DRAWINGS

FIG. 0 shows the shaving device of document WO 2009/081301. It does not seem to have a comb in this case to constitute a support point and to adjust a cutting length, but only a fixed blade and a mobile blade. The tilting axis of the cutting mechanism is distant from the cutting line and the support point is not aligned with the axis and the cutting line, which does not allow a constant cutting length.

FIGS. 1 and 2 show the beard trimmer as in the invention in three dimensions from several angles and with the cutting unit in two different positions. In this figure, the left side and its camber have been erased to better show the tilt mechanics.

FIG. 3 shows the advantageous use of the beard trimmer as in the invention with a capacity for automatically adapting the positioning of the cutting unit to the curves of the chin while maintaining the handle at a constant angle. With the support point of the comb in the immediate vicinity of the tilting axis and globally aligned with the cutting lines and the tilting axis, a same cutting length is obtained regardless of the tilting angle “α” of the cutting unit.

FIGS. 4 and 5 show a detailed view of the cutting unit of the beard trimmer as in the invention with the support point of the comb and the tilting axis. FIG. 5 also shows a spring that maintains the cutting head idle in an advanced position. It is the bearing action of the user that exerts pressure on said spring and automatically modifies the angle. Without pressure, the spring always returns the cutting head back to its initial position.

FIGS. 6 and 7 show the adjustment of the cutting length by varying the distance between the cutting line and the support point of the comb. The two extreme positions are shown; they allow a cutting length between about 0.5 and 6 mm. In that case, the cutting length is adapted by moving the comb. This movement is preferably motorized and the cutting mechanism is fixed and practically located on the tilting axis. This is the case where the tilting axes, the cutting line and the support point are globally superimposed.

FIGS. 8 and 9 show an exploded view of the beard trimmer as in the invention. All of the main elements, such as the motor, the batteries, the mechanical transmission of the cutting unit movement and the adaptation of the distance between cutting line and support point of the comb are shown.

FIGS. 10a to 10d show the possibility of bending the comb away and even of fixing it on the handle in order to clean the cutting mechanism and to use it against the skin allowing precise trimming of the edges of the beard and sideburns.

FIGS. 11 and 12 show two extreme positions of the comb relative to the cutting mechanism in order to adapt the cutting length. In this specific case, the cutting length is adapted by moving the cutting mechanism while the comb remains stationary. In FIG. 11, the tilting axes, the cutting line and the support point are globally superimposed. In FIG. 12, they are globally aligned.

FIG. 13 shows two extreme positions of the cutting mechanism when it moves relative to the comb in order to adapt the cutting length. In this specific case, the comb is stationary and the cutting mechanism moves to adjust the cutting length. This is a diagrammatic view of what happens in FIGS. 11 and 12.

FIG. 14 shows the operation of the device as in the invention. The alignment of the pivot axes, of the cutting line and of the support point of the comb allows precise cutting and perfect adjustment of the cutting length despite the curves of the face causing the tilting of the cutting mechanism.

FIG. 15 is a detailed view of the construction of the cutting mechanism mounted to as to tilt on the handle. It shows the fixed blade and the mobile blade forming the cutting line and the positionable comb. The return spring is also shown, as well as the spring that maintains the fixed blade and the mobile blade against each other (compression spring).

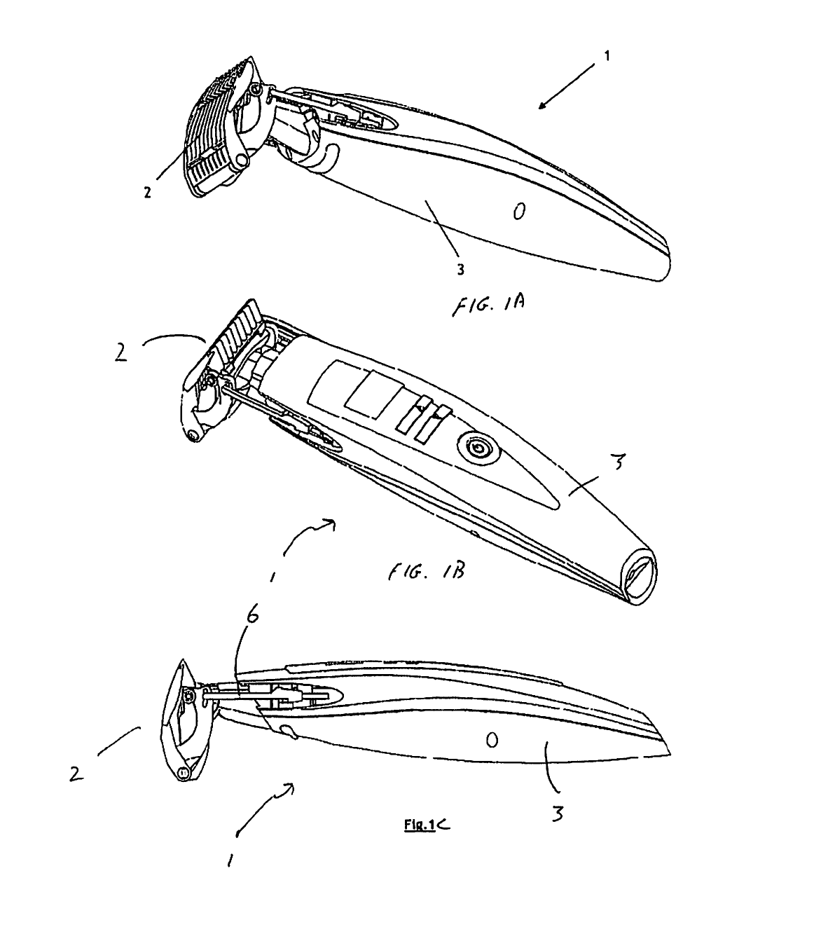

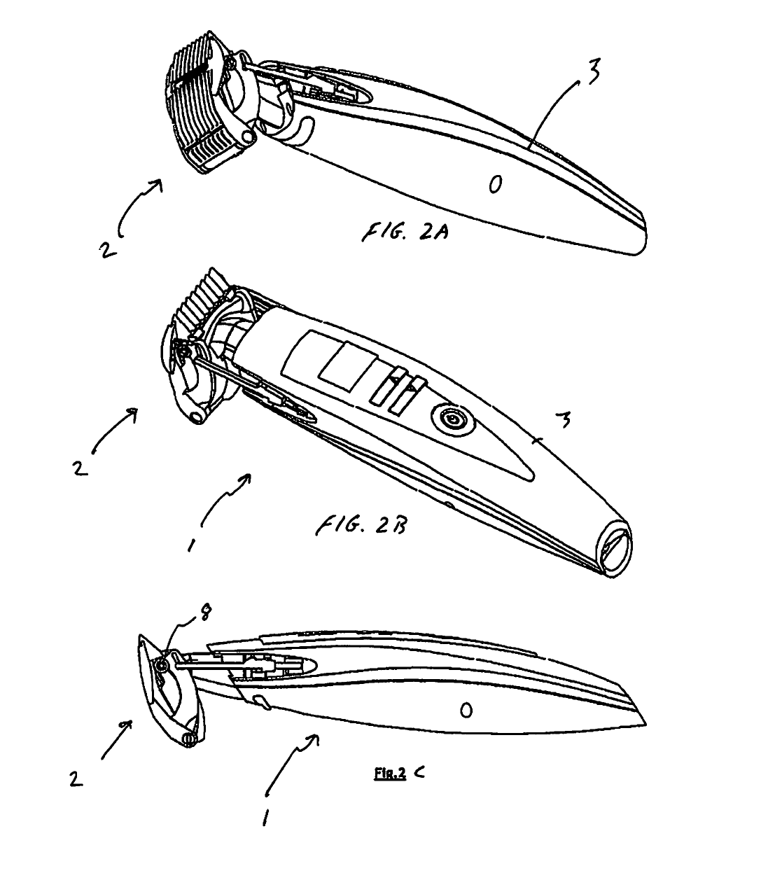

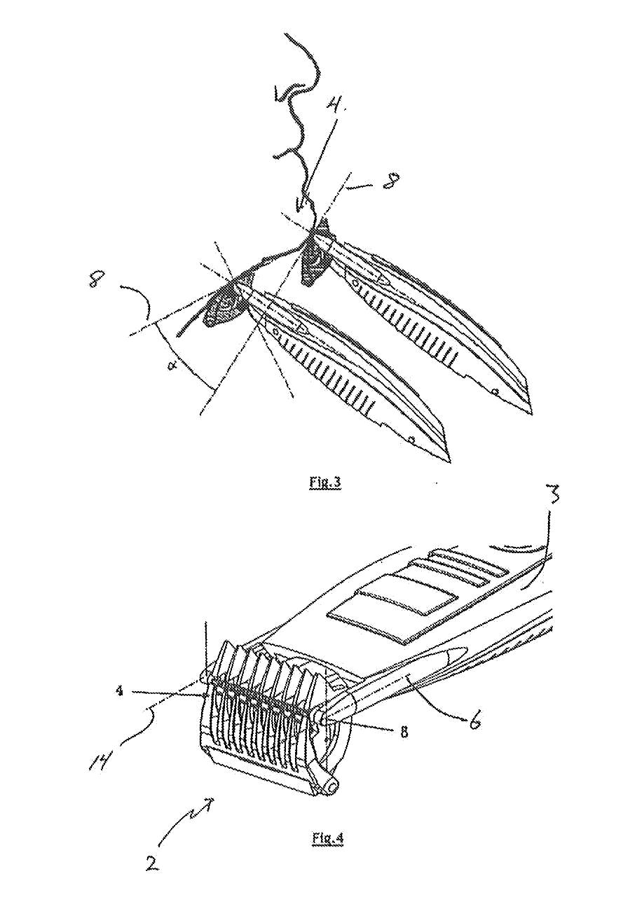

### NUMERAL REFERENCES OF THE DRAWINGS

1. Beard trimmer or trimmer
2. Cutting unit
3. Handle with motor block
4. Comb that may be positioned relative to the cutting line
5. Cutting line
6. Device for adjusting the cutting length and the rod that controls the keyhole
8. Tilting axis of the cutting unit
9. Cutting mechanism
10. Motor
11. Support point of the comb
12. Batteries
13. Return spring to bring the cutting unit back to its initial position
14. Axis of the handle
15. Fixed blade
16. Mobile blade
17. Compression spring maintaining the blades against each other

### DETAILED DESCRIPTION OF THE INVENTION

In order for the cutting unit 2 of a beard clipper or motorized trimmer to be mobile enough to automatically adapt its tilting angle optimally to the shape of the chin, it must above all be light. This can only be achieved by separating the motor function from the cutting unit and bringing the tilting axis of the cutting unit as close as possible to the skin, hence to the support point 11 on the comb 4. Moreover, the morphological constraints of the face mean that the cutting unit 2 must be as compact as possible to be able to work at the level of the mustache, for example.

The present invention discloses a beard trimmer 1 with a cutting unit 2 comprising a cutting mechanism 9 and at least one comb 4 providing a support point 11 of the cutting unit 2. The cutting unit 2 is hinged around a tilting axis 8 that is materialized by pivot points and maintained by one or two arms stretched in front of the handle 3 allowing the cutting unit 9 to tilt freely on an angle (a) that is sufficient to automatically adapt to the curves of the face.

The tilting axis is aligned in the extension of the handle so that the bearing force applied on the skin passes near the point of tangency of the curve of the face and is represented by the support point 11 of the comb 4. The support point 11 must be broadly understood and may be virtual. This is the case when the cutting length is very short and when the comb comprises a window to make room for the cutting line 5, which is this case is practically superimposed with the support point 11, both being also very close (3 to 4 mm) to the tilting axis. In practice, the support point 11 is even generally a small support surface, given the flexibility of the skin. The term “point” should therefore not be reduced to its strict geometric meaning.

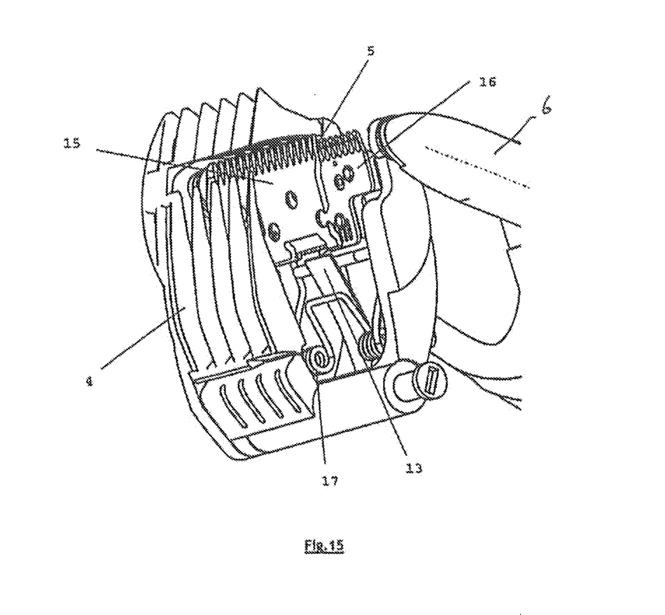

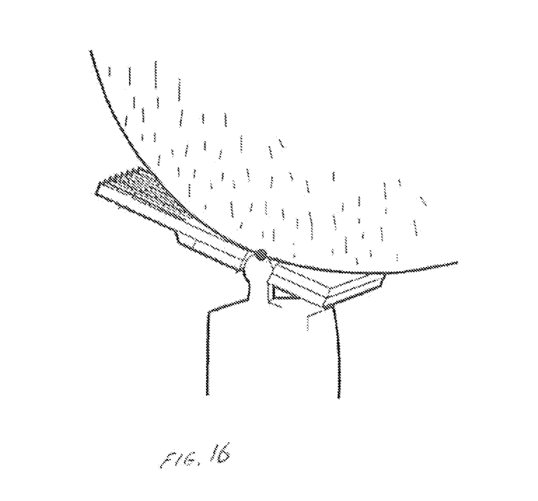

In order to maximally facilitate the rotation of the cutting unit 2 around the tilting axis 8, this axis must be as close as possible to the skin and hence to the support point 11 of the comb 4. “As close as possible” should be understood as what is geometrically feasible taking into account the bulk of the elements close to that axis. When the pivot points of the tilting axis 8 are located on the comb 4, this distance is hardly greater than 3 or 4 mm. This situation is shown in FIGS. 11 and 12. On the other hand, when the pivot points of the tilting axis 8 are located on the cutting mechanism, the distance between that axis and the skin varies as a function of the cutting length chosen by the user. This situation is shown in FIGS. 6 and 7. In that case, it nevertheless also does not exceed a distance of about 8 mm when the cutting length is adjusted to the maximum.

The aim of the beard trimmer as in the invention is to offer users a device with a small and light cutting unit that allows to trim the tiniest areas of the face and at the same time allows great freedom of movement, as it allows to maintain the arm in the same position for several different working angles.

To achieve that aim, the inventor has considerably lightened the cutting unit by conceptually separating it from the handle comprising the motor block and while ensuring a construction where the cutting line 5 and the tilting axis 8 are as close as possible to the skin and hence to the support point 11 of the comb 4, these three elements (8, 5 and 11) being globally aligned when the cutting length is 4 to 6 mm and globally superimposed when the cutting length is 0.3 to 0.5 mm. Here again, the term “superimposed” should be understood in a broad sense, and not in the geometric meaning, i.e. the elements 8, 5 and 11 located in a 3 to 4 mm space are considered as globally superimposed.

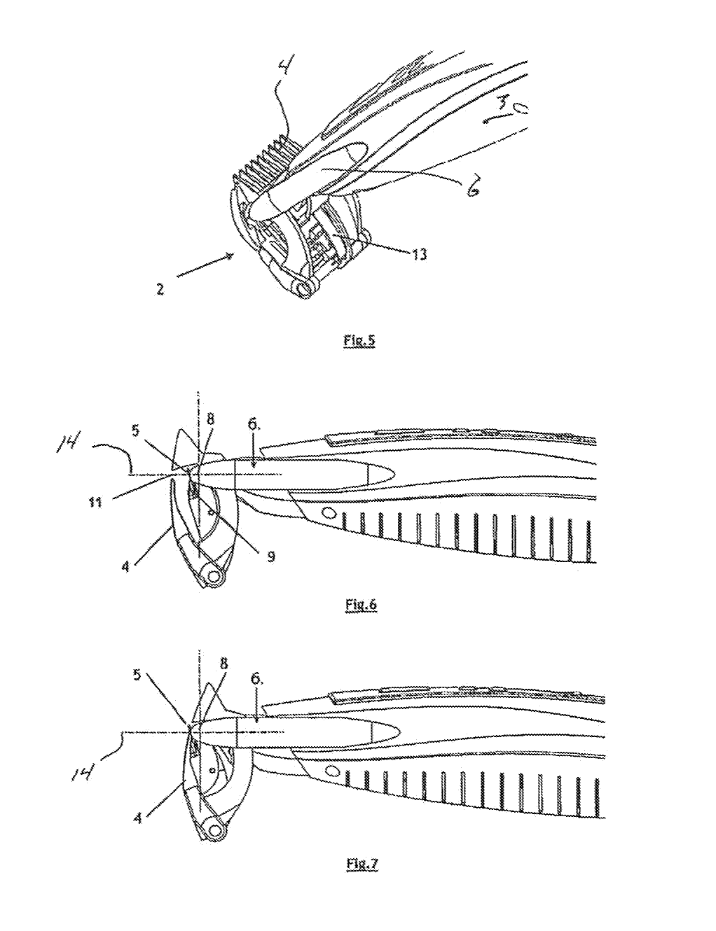

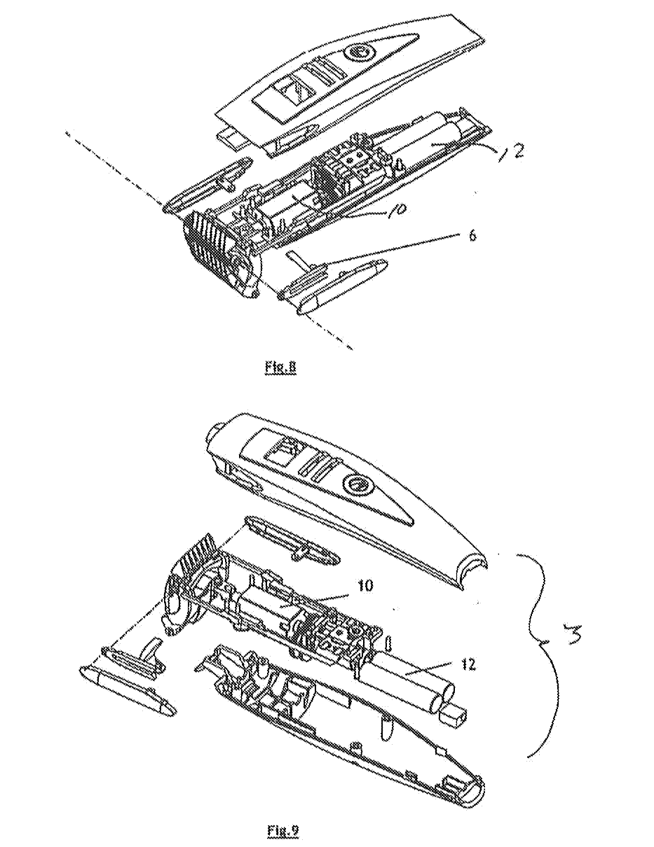

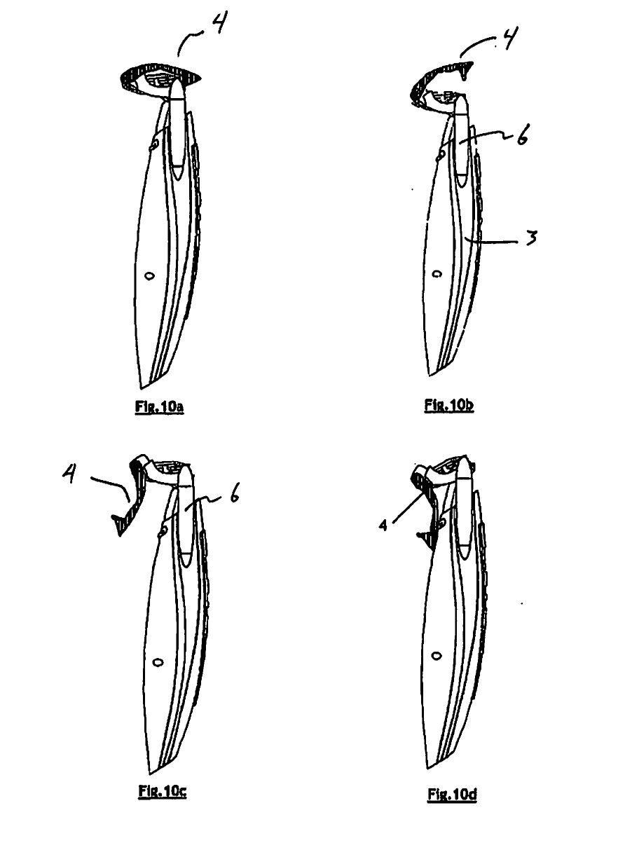

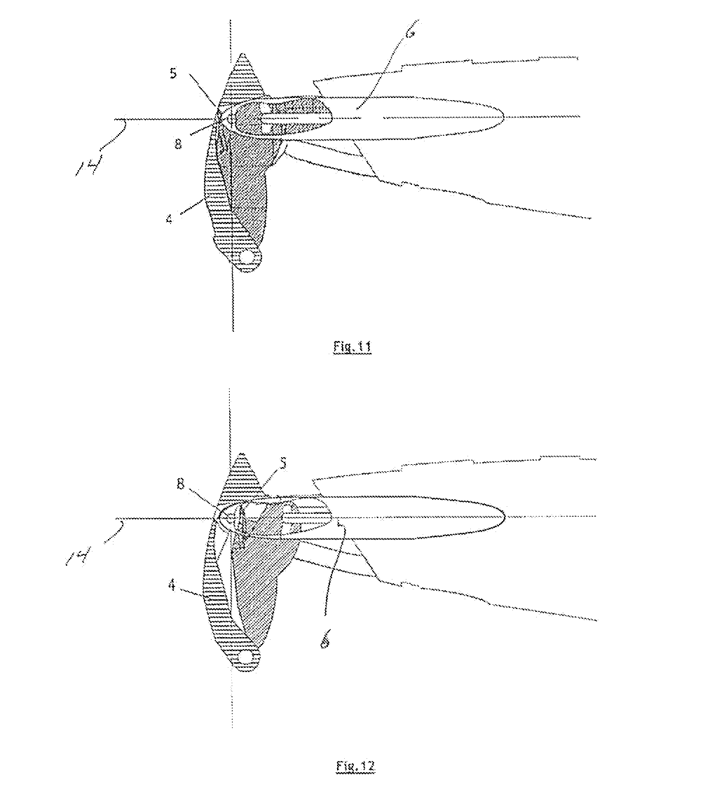

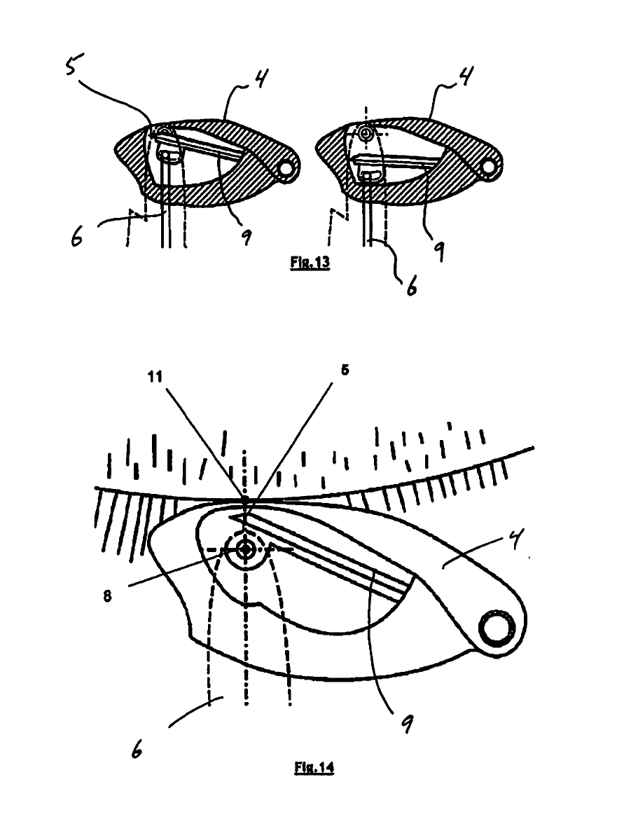

The freedom of movement of the cutting unit 2 around the tilting axis 8 may vary in a very wide range that may be between 10 and 90°. In practice, it is however around 40°, and in the illustrated case in the order of 25°. A return spring 13 shown in FIGS. 5 and 15 always brings the cutting unit back to its initial position after application on the skin. The tilting angle greatly depends on the ratio of the tilting axis 8 and support point 11 of the comb 4 distances on the one hand, and on the length of the comb on the other. In the context of the present invention, the distance between the tilting axis 8 and the support point 11 of the comb 4 is as small as possible. The comb may comprise two parts, as in FIGS. 4, 6 and 7, with a window for the cutting line. This two-part configuration does not, however, allow to remove the comb by bending it as shown in FIGS. 10a to 10d. To be able to perform that operation, the comb must be made in a single piece as shown in FIGS. 5 and 10.

The distance between the support point 11 of the comb 4 and the cutting line 5 may be adapted by means of a motorized adjustment located on the handle of the beard trimmer as in the invention. This distance will determine the desired cutting length for the beard. The adjustment may easily and precisely be achieved if the user decides to trim his beard to different lengths depending on the areas. The adjustment may be achieved by adapting the position of the comb 4 and thus of the support point 11, which, in that specific case, requires mobility of the comb 4 (FIGS. 6 and 7). It may, however, also be achieved by maintaining the comb 4 stationery and by adapting the position of the cutting line 5, which then requires mobility of the cutting mechanism 9 (FIGS. 11 and 12).

The handle may also comprise an indication of the desired cutting length; it generally varies from 0.3 to 6 mm, preferably from 0.5 to 5 mm.

The present invention is based on its priority application, which we incorporate into the present application by reference.

1. A beard trimmer comprising:
a handle;
a cutting unit mounted to the handle, the cutting unit including a cutting mechanism defining a cutting line and a comb defining a support point,
said cutting unit being mounted so as to tilt on the handle (3), the tilting axis of the cutting unit, the cutting line and the support point of the comb being generally globally aligned or superimposed, allowing said cutting unit to be automatically positioned tangentially to the shape of the face during trimming of the beard.

2. The beard trimmer as in claim 1, wherein the tilting axis of the cutting unit is materialized by pivot points located on the cutting mechanism.

3. The beard trimmer as in claim 1, wherein the tilting axis of the cutting unit is materialized by pivot points located on the comb.

4. The beard trimmer as in claim 1, wherein the tilting axis (8) of the cutting unit is located less than 8 mm, preferably less than 5 mm, from the support point of the comb.

5. The beard trimmer as in claim 1, wherein the tilting angle (α) of the cutting unit around the tilting axis is greater than 10°, preferably greater than 20°.

6. The beard trimmer as in claim 1, wherein the tilting angle (α) of the cutting unit around the tilting axis is between 15 and 90°.

7. The beard trimmer as in claim 1, wherein the cutting unit is maintained in an idle position by a return spring, said return spring biasing said cutting unit towards said initial idle position.

8. The beard trimmer as in claim 1, wherein the distance between the support point of the comb and the cutting line is adjustable.

9. The beard trimmer as in claim 8, including a motorized adjustment mechanism, the motorized adjustment mechanism adapted to adjust the distance between the support point on the comb and the cutting line without interrupting the trimming of the beard.

10. The beard trimmer as in claim 8 wherein the distance between the support point of the comb and the cutting line is adjusted by moving the cutting mechanism when the pivot points materializing the tilting axis are located on the comb.

11. The beard trimmer as in claim 8 wherein the distance between the support point of the comb and the cutting line is adjusted by moving the comb when the pivot points materializing the tilting axis are located on the cutting mechanism.

12. The beard trimmer as in claim 8 wherein the handle comprises a cutting-length indicator connected to a mechanism for adjusting the distance between the cutting line and the support point of the comb (11).

13. The beard trimmer as in claim 12, wherein the cutting length may be adjusted between 0.3 and 6 mm, preferably between 0.5 and 5 mm.

14. A hair trimmer apparatus, which comprises:
a handle defining a longitudinal axis;
a cutting mechanism including at least one blade and a comb mounted adjacent the blade, the cutting mechanism mounted to pivot relative to the handle about a pivot axis to permit adjustment of an orientation of the cutting mechanism when applied to a face or head of a subject, the at least one blade and the comb adapted for relative longitudinal movement to selectively vary a cutting length of the cutting mechanism; and
a motor to control operation of the at least one blade of the cutting mechanism.

15. The hair trimmer apparatus according to claim 14 wherein the comb is adapted for longitudinal movement with respect to the longitudinal axis to selectively vary the cutting length.

16. The hair trimmer apparatus according to claim 15 wherein including an adjustment member associated with the handle to selectively control the longitudinal movement of the comb.

17. The hair trimmer apparatus according to claim 16 wherein the comb is adapted for longitudinal movement with respect to the longitudinal axis through a motarized adjustment.

18. The hair trimmer apparatus according to claim 14 wherein the at least one blade is adapted for longitudinal movement with respect to the longitudinal axis to selectively vary the cutting length.

19. The hair trimmer apparatus according to claim 14 wherein the cutting mechanism is adapted to pivot between an initial position and a pivoted position, and is normally biased to the initial position.

20. The hair trimmer apparatus according to claim 19 wherein the cutting mechanism is adapted to pivot between a pivot angle ranging from about 15 degrees to about 90
